(19) United States
(12) Patent Application Publication
(10) Pub. No.: US 2022/0172535 A1
(43) Pub. Date: Jun. 2, 2022

(54) A COMPUTER IMPLEMENTED METHOD FOR ALLOWING THIRD-PARTY ACCESS TO A PREMISE

(71) Applicant: AMIDO AB (publ), Göteborg (SE)

(72) Inventors: Andreas SELSTAM, LINDOME (SE); Johnny BERLIC, GÖTEBORG (SE); Oskar BERGGREN, LONDON (GB); Peo EMGÅRD, GÖTEBORG (SE); Torbjörn HALL, GÖTEBORG (SE)

(73) Assignee: AMIDO AB (publ), Göteborg (SE)

(21) Appl. No.: 17/601,774

(22) PCT Filed: Apr. 7, 2020
(86) PCT No.: PCT/SE2020/050362

§ 371 Date: Oct. 6, 2021

(30) Foreign Application Priority Data
Apr. 8, 2019 (SE) 1950437-2

(51) Int. Cl. G07C 9/00

(52) U.S. Cl. CPC G07C 9/00571; G07C 2209/08

(57) ABSTRACT

The present disclosure relates to a computer implemented method of entry handling, specifically adapted for allowing third-party access to a premise. According to this method an intermediate server is provided for coordinating how an electronic entry arrangement associated with a first user may be allowed to be controlled by a third-party, such as for example a contractor requiring access to the first user's premise using the electronic entry arrangement. Accordingly, the first user does not need to share his own electronic key, since the server function as an intermediate handler of access rights.

### TECHNICAL FIELD

The present disclosure relates to a computer implemented method of entry handling, specifically adapted for allowing third-party access to a premise. The present disclosure also relates to a corresponding entry handling system and a computer program product.

### BACKGROUND

Conventionally, mechanical locks have been used to provide secure closure of a user's premise, etc., where the mechanical locks typically are opened via a physical key. Recent development involving the use of electronic locks allow for a streamlined approach in allowing access to said user premise or premises. Electronic keys for unlocking/locking the electronic locks may be easily distributed and revoked. For example, in hotels and enterprises, electronic locks and appropriate electronic keys are widely used, providing flexible management of access rights.

However, as soon as the infrastructure gets more complex, such as with an increasing number of premises and electronic locks, such as in relation e.g. a large or sprawling complex, it is necessary to provide a system administrator or system user with the ability to monitor and/or control the operation of electronic locks from a computer station, for example by connecting the electronic locks to a data network via a wireless local area network (WLAN). However, the costs associated with installing, connecting, and maintaining such a system may be prohibitive.

U.S. Pat. No. 8,635,462 tries to solve this by a specifically configured device for managing access control, where access authorizations are stored and managed in a central processor. Electronic keys are programmed with authorization information for a pregiven selection of locking units as a function of the respective access authorization, the authorization information is wirelessly sent from a key to a locking unit in the event of an access request, and the access authorization is determined in the locking unit as a function of the received authorization information, the programming of a key comprises the sending of the authorization information via a wireless telecommunication network to a wireless mobile telecommunication device and the transmitting of the authorization information received by the mobile telecommunication device to a memory of the key.

Even though U.S. Pat. No. 8,635,462 presents an interesting approach in managing a complex electronic key infrastructure, U.S. Pat. No. 8,635,462 is completely silent in regards to handling of distributed access rights, such as for allowing a user to share an electronic key with a third-party, such as a contractor that needs access to a user's premises even when the user is not present.

With this in mind, it would be desirable to further improve the access control management, with specific focus on allowing an end user to be given at least partial access control, such as for example for allowing the end user to be involved in how keys are shared with third-parties.

### SUMMARY

According to an aspect of the present disclosure, the above is at least partly met by a computer implemented method for entry handling, the method comprising the steps of receiving, at a server, a request to allow a first contractor to operate a first electronic entry arrangement associated with a first user, the request comprising credentials for the first electronic entry arrangement, acquiring, using the server and from a database arranged in networked communication with the server, predetermined access data for the first electronic entry arrangement, where the predetermined access data defines digitally implemented contracts in advance formed between the first user and the first contractor, determining, at the server, first access rights for the first electronic entry arrangement by comparing the credentials and the predetermined access data for the first electronic entry arrangement, forming, at the server, a first access key for the first electronic entry arrangement based on the first access rights, and providing, using the server, the first access key to allow the contractor to operate the first electronic entry arrangement.

By means of the present disclosure, an intermediate server is provided for coordinating how an electronic entry arrangement associated with a first user may be allowed to be controlled by a third-party, such as for example a contractor requiring access to the first user's premise using the electronic entry arrangement. Accordingly, the first user does not need to share his own electronic key, since the server function as an intermediate handler of access rights.

In the context of the invention, the term “electronic entry arrangement” is meant to comprise electric, electronic or mechatronic locking units and, in particular, locks. In this respect, electronic entry arrangement can comprise various components such as, e.g., read-out means for identification media, particularly electronic keys, a locking electronics system and the like. In line with the present disclosure, the server is arranged in networked communication with a user electronic device associated with the first user for receiving the request, for example allowing the user to provide the request, for example comprising a user ID, to the server using an app executed at a mobile phone of the first user. The term premise should furthermore be understood to mean any form of closed space associated with a user, such as an office, a home, a vehicle, etc.

The first user may thus ensure that e.g. a specific first contractor (or type of contractor) is given a specific level of access. By implementing the predetermined access data as contracts advantageously allows for trackability of the access rights as well as possibly allowing the contracts to be criteria based as well as time dependent. A criteria-based contract may for example only allow a specific first contract access to perform tasks that have been agreed upon in beforehand. Correspondingly, time-based contacts could possibly dictate when (duration and/or time of the day) when the specific contractor is allowed access.

In accordance to the present disclosure, the user or a representative of the first user has previously arranged the database to hold access data for the first electronic entry arrangement. The access data is in turn compared to the credentials provided by the first user, whereby a key for the contractor may be formed. An advantage following the present disclosure is thus that the first user may at any time by means of the request allow swift access for the contractor, without having to resort to direct communication with the contractor.

In an embodiment of the present disclosure, the first access key is provided to a computing device associated with the contractor. As an example, the computing device associated with the contractor may be e.g. a mobile phone or similar device that can be arranged to hold the access key e.g. wirelessly interact with and operate the first electronic entry arrangement associated with a first user.

In an alternative embodiment, the first access key may be associated with the first electronic entry arrangement. In such an embodiment, for example the contractor may provide the intermediate server with information relating to e.g. an electronic key, such as a RFID or NFC device, where the electronic key comprises identifiable information. The first electronic entry arrangement may by the above association with the first access key be arranged to allow the contractor's electronic key to operate the first electronic entry arrangement, in case it is determined that the identifiable information matches the information previously provided by the contractor.

The concept as presented in accordance to the present disclosure may also be used for setting a defined access time for when the contractor may access e.g. the first user's premise. Accordingly, in an exemplary embodiment of the present disclosure the request further comprises an operational time-frame and the step of forming the first access key comprises setting a validity time-frame, the validity time-frame being dependent on the operational time-frame. The user may accordingly dictate also during which time span the contractor is allowed to access the user's premises, ensuring that no unwanted access is allowed e.g. when the user does not want any contractor to arrive at the premise. This thus ensure a high level of privacy and security for the user.

In a possible implementation of the present disclosure, the user may not have direct access to manage e.g. his own lock, i.e. the first electronic entry arrangement. For example, the first electronic entry arrangement may be managed by a first entry provider, for example providing a platform for controlling the operation of the first electronic entry arrangement. In such an embodiment, the first entry provider may be arranged to receive and forward the predetermined access data from the user electronic device associated with the first user to the server as defined above, i.e. defined as the intermediate server.

In line with the present disclosure it should be understood that the concept of course scales to more than a single user, such as also including a second, a third, etc. user. In use the concept may comprise many thousands or millions of users. Accordingly, each of the users has his associated electronic entry arrangement, and performs the above process for forming thereto related access keys.

Accordingly, the server will communicate with the first entry provider, where the first entry provider in turn will be arranged to communicate with the first user. The intermediate server may accordingly be arranged to allow a plurality of different entry providers (e.g. a first, a second, a third, etc. entry provider), where the different entry providers manage different types of electronic entry arrangements, such as different brands of electronic entry arrangements. As such, the intermediate server will allow a plurality of different contractors to be allowed entry to premises secured using a plurality of different types of electronic entry arrangements.

In an embodiment of the present disclosure the contractor is associated with one of a plurality of contractor types. That is, different contractors may be of different “types”, where such types may include (but not limited to) delivery personnel for different online grocery stores, service personnel for different type of household appliances, etc. Accordingly, the first user may advantageously make a single request to thereby allow e.g. more than a single grocery store to deliver groceries to the first user's premise.

Preferably, the predetermined access data for the first electronic entry arrangement is based on an electronically signed agreement between the first contractor and the first user. Thus, the first user may at an earlier stage connect to the intermediate server for forming a contract, where the contract confirms that the first user allows the contractor access to the premise of the first user.

Generally, the contractor may in turn request for a sub-contractor to perform the “action” at the first user's premise. For example, the contractor may be the above-mentioned online grocery store, and the sub-contractor may be a company/person assigned to for delivery of groceries ordered by the first user to the first user's premise. Accordingly, in a preferred embodiment of the present disclosure the computing device associated with the contractor is adapted to provide the first access key to a computing device associated with a sub-contractor. As such, the contractor may relay the first access key to the sub-contractor for allowing the sub-contractor to access the first user's premise.

According to another aspect of the present disclosure there is provided an entry handling system comprising a server and a database, wherein the computer system is adapted to receive, at a server, a request to allow a first contractor to operate a first electronic entry arrangement associated with a first user, the request comprising credentials for the first electronic entry arrangement, acquire, using the server and from a database arranged in networked communication with the server, predetermined access data for the first electronic entry arrangement, where the predetermined access data defines digitally implemented contracts in advance formed between the first user and the first contractor, determine, at the server, first access rights for the first electronic entry arrangement by comparing the credentials and the predetermined access data for the first electronic entry arrangement, form, at the server, a first access key for the first electronic entry arrangement based on the first access rights, and provide, using the server, the first access key to allow the contractor to operate the first electronic entry arrangement. This aspect of the present disclosure provides similar advantages as discussed above in relation to the previous aspect of the present disclosure.

According to a still further aspect of the present disclosure there is provided a computer program product comprising a computer program product comprising a non-transitory computer readable medium having stored thereon computer program means for operating an entry handling system, wherein the system comprises a server and a database, and the computer program product comprises code for receiving, at a server, a request to allow a first contractor to operate a first electronic entry arrangement associated with a first user, the request comprising credentials for the first electronic entry arrangement, code for acquiring, using the server and from a database arranged in networked communication with the server, predetermined access data for the first electronic entry arrangement, where the predetermined access data defines digitally implemented contracts in advance formed between the first user and the first contractor, code for determining, at the server, first access rights for the first electronic entry arrangement by comparing the credentials and the predetermined access data for the first electronic entry arrangement, code for forming, at the server, a first access key for the first electronic entry arrangement based on the first access rights, and code for providing, using the server, the first access key to allow the contractor to operate the first electronic entry arrangement. Also this aspect of the present disclosure provides similar advantages as discussed above in relation to the previous aspects of the present disclosure.

A software executed by the server for operation in accordance to the present disclosure may be stored on a computer readable medium, being any type of memory device, including one of a removable nonvolatile random-access memory, a hard disk drive, a floppy disk, a CD-ROM, a DVD-ROM, a USB memory, an SD memory card, or a similar computer readable medium known in the art.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates an entry handling system according to a currently preferred embodiment of the present disclosure, and

FIG. 2 shows a flow chart of a method according to an embodiment of the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

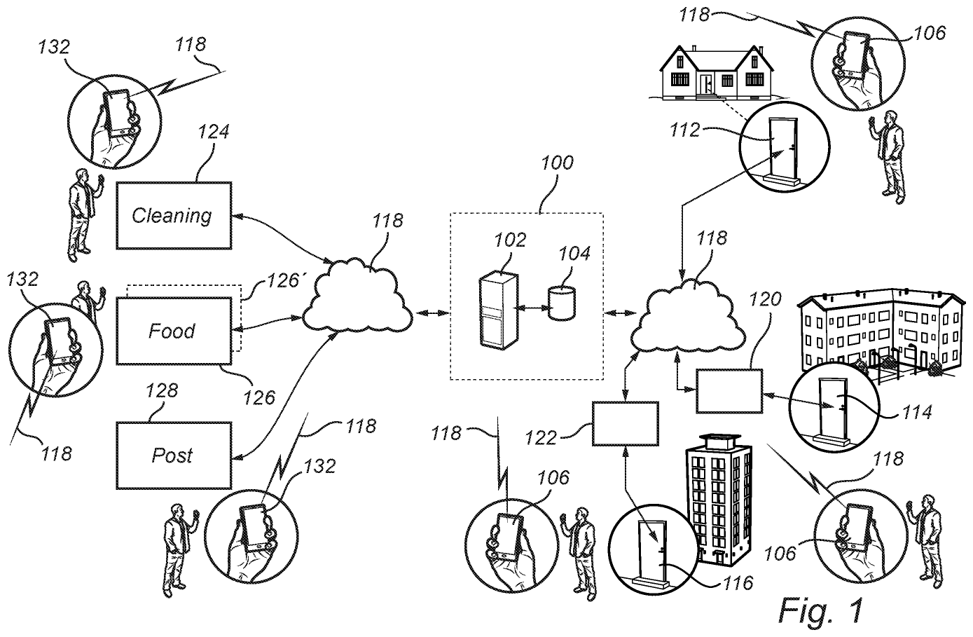

Referring now to the drawings and to FIG. 1 in particular, there is depicted an entry handling system 100 according to a possible embodiment of the present disclosure. The entry handling system 100 comprises a server 102 and a database 104 arranged in communication with each other. The server 102 is arranged in networked communication with a first, a second and a third user operating a respective electronic user device 106, 108, 110.

The first, the second and third user is also associated with a respective electronic entry arrangement 112, 114, 116. The electronic entry arrangements 112, 114, 116 may for example include electronic locks securing premises for the first, second and third user.

The electronic user devices 106, 108, 110 may for example be selected to be at least one of mobile phones, tablets, personal computers, etc. The electronic user devices 106, 108, 110 typically presents a graphical user interface (GUI) adapted to be handled by the respective user. The electronic user devices 106, 108, 110 may for example be connected to the server 102 using a networked connection 118, such as the Internet.

The networked connection 118 may be in part be wired or wireless, including for example wired connections like a building LAN, a WAN, an Ethernet network, an IP network, etc., and wireless connections like WLAN, CDMA, GSM, GPRS, 3G mobile communications, 4G mobile communications, Bluetooth, infrared, or similar.

The server 102 may in one embodiment be a cloud-based server. Thus, the computing power provided by means of the present disclosure may be distributed between a plurality of servers, and the location of the servers must not be explicitly defined. Advantageous following the use of a cloud-based solution is also the inherent redundancy achieved.

In the illustration as shown in FIG. 1, the first 112 and the second 114 electronic entry arrangement is managed by a first 120 and a second 122 entry provider. In such an embodiment, the entry provider functions to form a connection between the electronic entry arrangements 112, 114 and the server 102. Such an implementation may be possible in many situations since the electronic entry arrangements 112, 114 by themselves may not be configured (or allowed) to form a direct connection with e.g. a third-party (which in this case is the server 102). Such an implementation is for example common in relation to an apartment or office complex, etc., where a large number of tenants share a common proprietor “electronic lock system”. It should be understood that the first 120 and the second 122 entry provider provides for example may be seen as providers of e.g. different brands of electronic locks or being a large-scale provider of a “electronic lock solution”.

However, it is possible and in line with the present disclosure to allow for the electronic entry arrangement, such as is exemplified with the third electronic entry arrangement 116, to form a direct connection with the server 102.

The server is also connected to a plurality of computing devices 124, 126, 128, each associated with a contractor. In the illustrated embodiment the contractors are exemplified as a cleaning service, an online grocery store and a postal delivery service, each operating the respective computing devices 124, 126, 128. Also, the computing devices 124, 126, 128 are connected to the server 102 using a networked connection.

Still further, in FIG. 1 a sub-contractor is associated with the each of the contactors, where the sub-contractor in an embodiment may be defined as “an entity performing a portion of an actual function of the contractor” (such as e.g. a cleaner, a grocery delivery person, a postal delivery person, respectively). The sub-contractors are each assigned a computing device 130, 132, 134. The function and use of the computing devices 130, 132, 134 will be elaborated below.

In accordance to the present disclosure and as shown in FIG. 1, the database 104 stores predetermined access data for each of the electronic entry arrangements 112, 114, 116. The predetermined access data may in one embodiment be defined as digitally implemented contracts in advance formed between users and the contractors. A further computing device 126′ is illustrated in FIG. 1, representing another online grocery store (such as a different brand). In an embodiment of the present disclosure the two different online grocery stores are considered to be of the same type. The predetermined access data may in line with the discussion above be implemented to relate to a contractor type. Taking the online grocery stores as an illustrative example, the user may thus form a general contract that is contractor type dependent, meaning that contractors of the same type are allowed access to the user. By such an implementation the user must not form a new contract if switching between contractors of the same type (such as if switching between different online grocery stores).

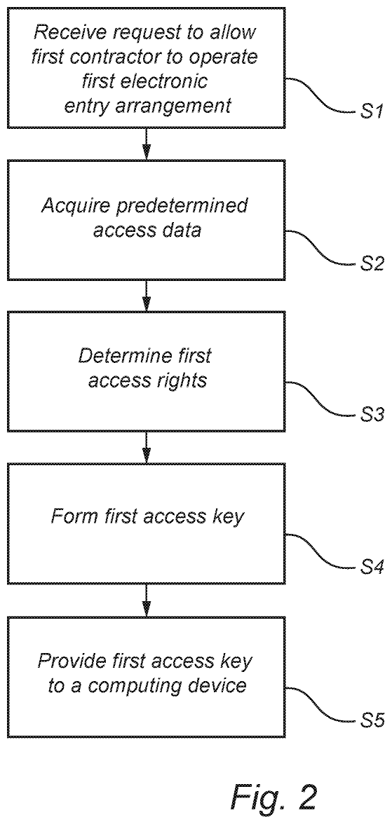

During operation of the entry handling system 100, with further reference to FIG. 2, the process may for example start by one of the user's ordering a cleaning service from a cleaning contractor. In relation to FIG. 1, the first user may for example use an app installed on his electronic user device 108 to order the cleaning service. In scheduling the cleaning, the first user wants to allow the cleaning service access to his premises even if not being home himself. Accordingly, the first user sends a request for allowing the cleaning service to operate the electronic entry arrangement 112 associated with the first user. The request comprises credentials for the first user, such as an ID and a password for the first user and information relating to the contractor that is to be allowed to operate the electronic entry arrangement 112 associated with the first user. The request may also, as discussed above, comprise a time frame for when the contractor is allowed to operate the electronic entry arrangement 112 associated with the first user. Furthermore, the request may comprise geographic details for the electronic entry arrangement 112.

Since the first user lives in an apartment complex, the first user's premise may in some situations be secured by not only the personal electronic entry arrangement 112, but also a common electronic entry arrangement (not shown), securing the apartment complex occupied by the first user. Thus, to enter the premises of the first user the contractor or the sub-contractor must operate both the common electronic entry arrangement and the personal electronic entry arrangement 112.

In such an embodiment, it may be desirable that the predetermined access data associated with the personal electronic entry arrangement 112 is “inherent” by the common electronic entry arrangement provided by the entry provider. Thus, in case the first user forms a digitally implemented contract with the contractor in regards to the personal electronic entry arrangement 112, this contract will automatically form access rights for the common electronic entry arrangement.

The request sent by the first user's electronic user device 108 is then received, S1, by the server 102. In the example as provided in FIG. 1 in relation to the first user, it may be possible that the request is relayed by the entry provider 120.

The server 102 will in turn acquire, S2, the predetermined access data for the first electronic entry arrangement 112 from the database 104, and then compare the credentials and the predetermined access data for the first electronic entry arrangement 112. If the comparison is successful the server 102, will determine, S3, first access rights for the first electronic entry arrangement 112, where the first access rights are used for forming, S4, a first access key for operating the first electronic entry arrangement 112.

Subsequently, the first access key for operating the first electronic entry arrangement 112 is provided, S5, to the computing device 124 associated with the contractor, in this example the cleaning service. In some embodiments, the cleaning service employs a plurality of cleaning personnel assigned to perform the task of cleaning. In line with the above example, the contractor may in turn provide the first access key to a computing device associated with a sub-contractor, such as computing device 130 associated with a cleaning person associated with the cleaning service.

When the cleaning person is to perform the cleaning service at the premise of the first user, the cleaning person will bring the computing device 130, for example a mobile phone, to the first user's premise. The mobile phone 130 may for example be equipped with near field communication (NFC) transceiver (other technologies are also possible, such as RFID) and the common as well as the personal electronic entry arrangement 112 may be provided with corresponding means for allowing the mobile phone to form a direct connection with the respective electronic locks. Other implementations for operating the respective electronic locks as well as other locks are possible and within the scope of the present disclosure. Verifying the operation of the common as well as the personal electronic entry arrangement 112 may be done in accordance to different methods, known and future.

As also discussed above, in an alternative embodiment, the first access key may be associated with the first electronic entry arrangement. In such an embodiment, for example the contractor may provide the intermediate server with information relating to e.g. an electronic key, such as the mentioned RFID or NFC device, where the electronic key comprises identifiable information. The first electronic entry arrangement may by the above association with the first access key be arranged to allow the contractor's electronic key to operate the first electronic entry arrangement, in case it is determined that the identifiable information matches the information previously provided by the contractor.

In line with the embodiment where the first access key is be associated with the first electronic entry arrangement, it may also be possible to allow the contractor or sub-contractor to be allowed to operate the electronic lock in case he is otherwise correctly identified. For example, the electronic lock may be provided with means for allowing the contactor (or sub-contractor) to be identified in relation to the electronic lock. Such an identification may for example be achieved using biometric data (such as face, finger, palm, iris, etc.) or using electronic signatures (such as BankID as used in Sweden). That is, the access key is “loaded” or otherwise associated with the electronic lock, and if the correct contractor (or sub-contractor) is correctly identified in relation to the electronic lock the electronic lock is correspondingly operated.

In summary, the present disclosure relates to a computer implemented method of entry handling, specifically adapted for allowing third-party access to a premise. The present disclosure also relates to a corresponding entry handling system and a computer program product.

By means of the present disclosure, an intermediate server is provided for coordinating how an electronic entry arrangement associated with a first user may be allowed to be controlled by a third-party, such as for example a contractor requiring access to the first user's premise locked using the electronic entry arrangement. Accordingly, the first user does not need to share his own electronic key, since the server function as said intermediate handler of access rights.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Although the figures may show a sequence the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A computer implemented method for entry handling, the method comprising the steps of:
receiving, at a server, a request to allow a first contractor to operate a first electronic entry arrangement associated with a first user, the request comprising credentials for the first electronic entry arrangement,
acquiring, using the server and from a database arranged in networked communication with the server, predetermined access data for the first electronic entry arrangement, where the predetermined access data defines digitally implemented contracts in advance formed between the first user and the first contractor,
determining, at the server, first access rights for the first electronic entry arrangement by comparing the credentials and the predetermined access data for the first electronic entry arrangement,
forming, at the server, a first access key for the first electronic entry arrangement based on the first access rights, and
providing, using the server, the first access key to allow the contractor to operate the first electronic entry arrangement.

2. The method according to claim 1, wherein the first access key is provided to a computing device associated with the contractor.

3. The method according to claim 1, wherein the step of providing comprises associating the first access key with the first electronic entry arrangement.

4. The method according to claim 1, wherein the server is arranged in networked communication with a user electronic device associated with the first user for receiving the request.

5. The method according to claim 2, wherein the computing device associated with the contractor is a mobile electronic device.

6. The method according to claim 1, wherein the request further comprises an operational time-frame and the step of forming the first access key comprises setting a validity time-frame, the validity time-frame being dependent on the operational time-frame.

7. The method according to claim 3, wherein the first electronic entry arrangement is operated by a first entry provider and the first entry provider is arranged to receive and forward the predetermined access data from the user electronic device associated with the first user to the server.

8. The method according to claim 1, wherein the contractor is associated with one of a plurality of contractor types.

9. The method according to claim 1, wherein the request comprising a user ID.

10. The method according to claim 2, wherein the predetermined access data for the first electronic entry arrangement is based on an electronically signed agreement between the first contractor and the first user.

11. The method according to claim 1, wherein the computing device associated with the contractor is adapted to provide the first access key to a computing device associated with a sub-contractor.

12. An entry handling system comprising a server and a database, wherein the computer system is adapted to:
receive, at a server, a request to allow a first contractor to operate a first electronic entry arrangement associated with a first user, the request comprising credentials for the first electronic entry arrangement,
acquire, using the server and from a database arranged in networked communication with the server, predetermined access data for the first electronic entry arrangement, where the predetermined access data defines digitally implemented contracts in advance formed between the first user and the first contractor,
determine, at the server, first access rights for the first electronic entry arrangement by comparing the credentials and the predetermined access data for the first electronic entry arrangement,
form, at the server, a first access key for the first electronic entry arrangement based on the first access rights, and
provide, using the server, the first access key to allow the contractor to operate the first electronic entry arrangement.

13. The system according to claim 12, wherein the first access key is provided to a computing device associated with the contractor.

14. The system according to claim 12, wherein providing the first access key comprises associating the first access key with the first electronic entry arrangement.

15. The system according to claim 12, wherein the server is arranged in networked communication with a user electronic device associated with the first user for receiving the request.

16. The system according to claim 13, wherein the computing device associated with the contractor is a mobile electronic device.

17. The system according to claim 12, wherein the request further comprises an operational time-frame and the step of forming the first access key comprises setting a validity time-frame, the validity time-frame being dependent on the operational time-frame.

18. The system according to any claim 1, wherein the first electronic entry arrangement is operated by a first entry provider and the first entry provider is arranged to receive and forward the predetermined access data from the user electronic device associated with the first user to the server.

19.-23. (canceled)

24. The system according to claim 12, wherein the electronic entry arrangement comprises an electronic lock.

25. A computer program product comprising a non-transitory computer readable medium having stored thereon computer program means for operating an entry handling system, wherein the system comprises a server and a database, and the computer program product comprises:
code for receiving, at a server, a request to allow a first contractor to operate a first electronic entry arrangement associated with a first user, the request comprising credentials for the first electronic entry arrangement,
code for acquiring, using the server and from a database arranged in networked communication with the server, predetermined access data for the first electronic entry arrangement, where the predetermined access data defines digitally implemented contracts in advance formed between the first user and the first contractor,
code for determining, at the server, first access rights for the first electronic entry arrangement by comparing the credentials and the predetermined access data for the first electronic entry arrangement,
code for forming, at the server, a first access key for the first electronic entry arrangement based on the first access rights, and
code for providing, using the server, the first access key to allow the contractor to operate the first electronic entry arrangement.
